(19) United States
(12) Patent Application Publication
(10) Pub. No.: US 2013/0082930 A1
(43) Pub. Date: Apr. 4, 2013

(54) KEYBOARD

(71) Applicants: LI-REN FU, Shenzhen City (CN); HAN-BING ZHANG, Shenzhen City (CN); AI-LING HE, Shenzhen City (CN); JUN-HUI WANG, Shenzhen City (CN)

(72) Inventors: LI-REN FU, Shenzhen City (CN); HAN-BING ZHANG, Shenzhen City (CN); AI-LING HE, Shenzhen City (CN); JUN-HUI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/304,387

(22) Filed: Nov. 24, 2011

(30) Foreign Application Priority Data
Sep. 30, 2011 (CN) 201110297329.5

(51) Int. Cl. G06F 3/02

(52) U.S. Cl. 345/168

(57) ABSTRACT

A keyboard includes a keyboard body and a block rotatably connected to the keyboard body. The keyboard body defines a receiving space for receiving a mouse pad. The receiving space extends through an end surface of the keyboard body. The block is operable to rotate into the receiving space to block the mouse pad.

### BACKGROUND

1. Technical Field

The present disclosure relates to a keyboard.

2. Description of Related Art

A keyboard and a mouse are often used together to input information into a computer. Generally, a mouse pad is used for supporting the mouse. However, the keyboard and the mouse pad are placed separated in use, and when not in use, the mouse pad can get lost, thus causing inconvenience to the user.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a partial, exploded, isometric view of an exemplary embodiment of a keyboard, together with a mouse pad.

FIG. 2 is an inverted view of FIG. 1

FIG. 3 is an assembled, isometric view of the keyboard and the mouse pad of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

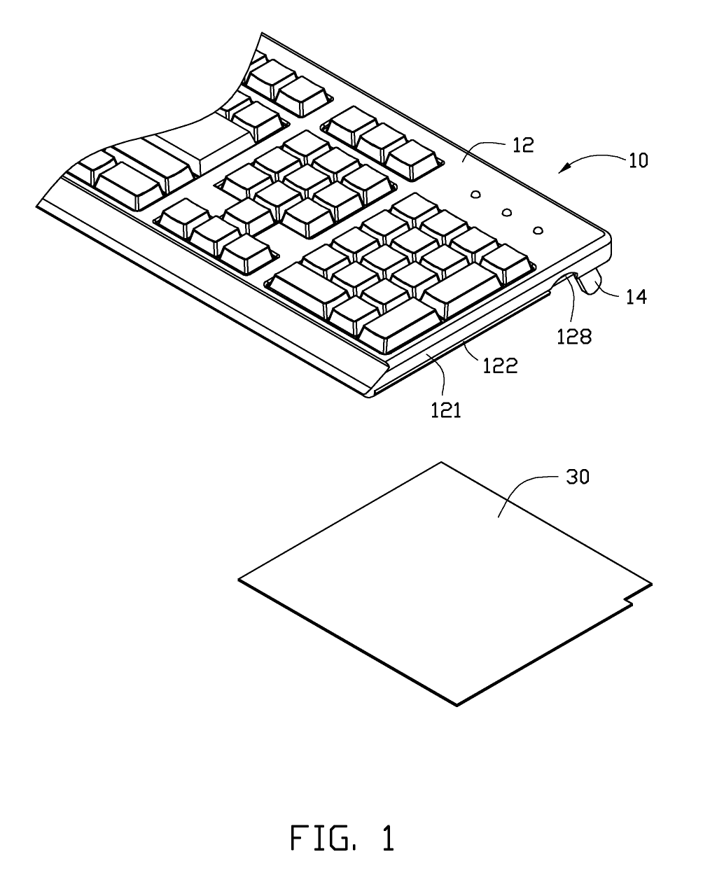

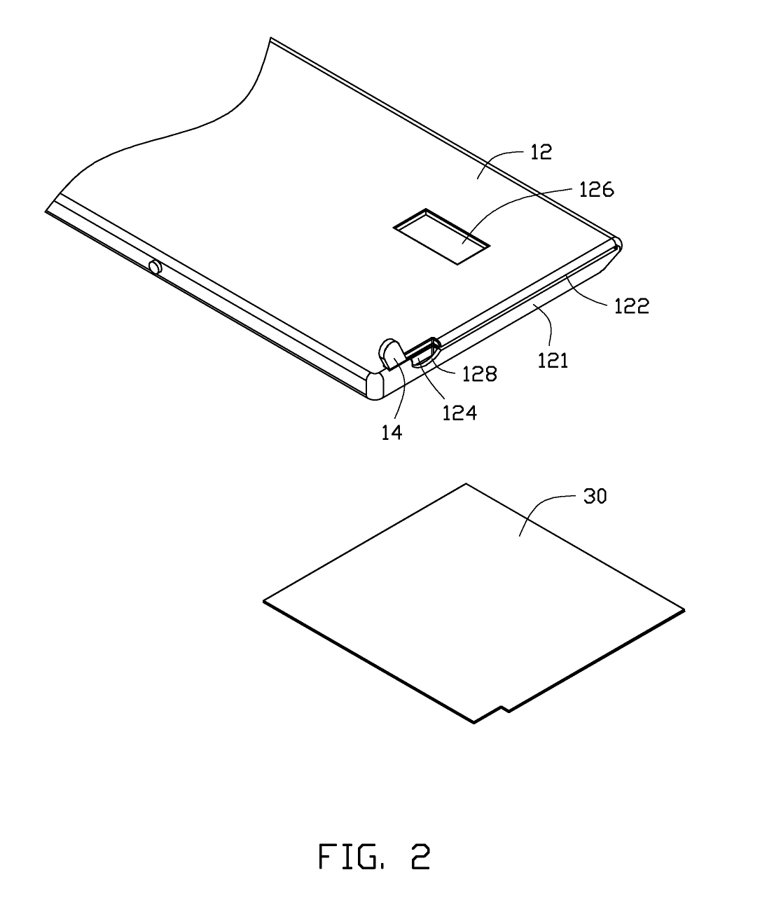

Referring to FIG. 1 and FIG. 2, an exemplary embodiment of a keyboard 10 for receiving a mouse pad 30 is provided.

The keyboard 10 includes a keyboard body 12. The keyboard body 12 defines a receiving space 122 extending through an end surface 121 of the keyboard body 12. A bottom of the keyboard body 12 defines an opening 126 communicating with the receiving space 122, and defines a latching slot 124 adjacent to the end surface 121 and communicating with the receiving space 122. A cutout 128 is defined in the end surface 121 and communicates with the latching slot 124. A block 14 is rotatably connected to the keyboard body 12. The block 14 is operable to rotate into the latching slot 124.

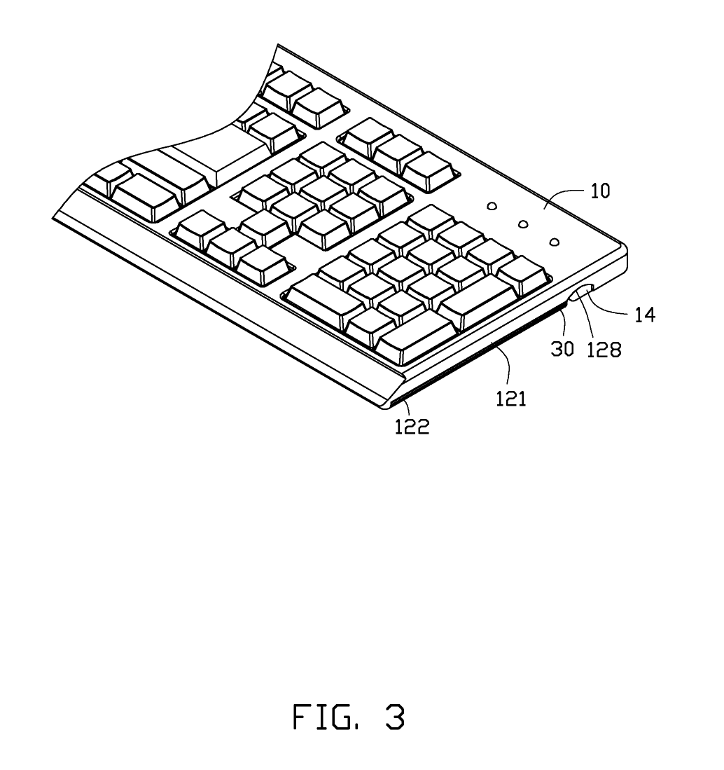

Referring to FIG. 3, when assembling the mouse pad 30, the mouse pad 30 is inserted into the receiving space 122 through the end surface 121. The block 14 is rotated into the latching slot 124, to block the mouse pad 30.

When disassembling the mouse pad 30, fingers of a user are used to rotate the block 14 from the cutout 128, allowing the block 14 to move out of the latching slot 124, thereby releasing the mouse pad 30. The fingers of the user then push the mouse pad 30 out of the receiving space 122 from the opening 126. After a part of the mouse pad 30 moves out of the receiving space 122, the mouse pad 30 may be easily separated from the keyboard body 12.

It is to be understood, however, that even though numerous characteristics and advantages of the embodiments have been set forth in the foregoing description, together with details of the structure and function of the embodiments, the present disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A keyboard comprising:
a keyboard body defining a receiving space for receiving a mouse pad, the receiving space extending through an end surface of the keyboard body; and
a block movably connected to the keyboard body, wherein the block is operable to move to block the mouse pad received in the receiving space.

2. The keyboard of claim 1, wherein a bottom of the keyboard defines a latching slot communicating with the receiving space and adjacent to the end surface, the block is operable to move into the latching slot to block the mouse pad.

3. The keyboard of claim 2, wherein a cutout is defined in the end surface and communicates with the latching slot, the block is rotated out the latching slot from the cutout.

4. The keyboard of claim 1, wherein a bottom of the keyboard body defines an opening communicating with the receiving space.

5. A keyboard assembly, comprising:
a keyboard body defining a receiving space extending through an end surface of the keyboard body;
a mouse pad detachably received in the receiving space; and
a block movably connected to the keyboard body, wherein the block is operable to move to block the mouse pad received in the receiving space.

6. The keyboard assembly of claim 5, wherein a bottom of the keyboard body defines an opening communicating with the receiving space, the mouse pad is pushed out the receiving space from the opening.

7. The keyboard assembly of claim 5, wherein a latching slot is defined in the keyboard body adjacent to the end surface, the block is operable to move to the latching slot to block the mouse pad.
